(19) United States
(12) Patent Application Publication
(10) Pub. No.: US 2006/0273619 A1
(43) Pub. Date: Dec. 7, 2006

(54) Automobile hinge

(76) Inventors: David R. Miller, Hudsonville, MI (US); John M. Morelli, Grand Rapids, MI (US); Robert N. Alt JR., Grand Rapids, MI (US); James Kiefer, Grand Rapids, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/390,759

(22) Filed: Mar. 28, 2006

Related U.S. Application Data
(63) Continuation-in-part of application No. 10/650,628, filed on Aug. 28, 2003, now Pat. No. 7,114,219.
(60) Provisional application No. 60/665,956, filed on Mar. 29, 2005.
(60) Provisional application No. 60/406,847, filed on Aug. 29, 2002.

(51) Int. Cl. B60J 5/10

(52) U.S. Cl. 296/146.8

(57) ABSTRACT

An automobile hinge for pivotally mounting a panel component to a vehicle body includes a panel attachment plate adapted to be secured to the panel of a vehicle, a body attachment plate securable to the vehicle body, and an intermediate member pivotably attached between the body attachment plate and the panel attachment plate. The automobile hinge includes a fastener element at the intermediate member with the fastener element being configured to receive a fastener to secure the intermediate member to the body attachment plate. The fastener element may include one or more securing elements to impede or limit movement of the fastener insert relative to the intermediate member.

### CROSS REFERENCE TO RELATED APPLICATIONS

The present application claims benefit of U.S. provisional application Ser. No. 60/665,956, filed Mar. 29, 2005, and is a continuation-in-part of U.S. patent application Ser. No. 10/650,628, filed Aug. 28, 2003, and published on Mar. 25, 2004 as U.S. Publication No. US-2004-0055112-A1, which claims benefit of U.S. provisional application Ser. No. 60/406,847, filed Aug. 29, 2002, which are all hereby incorporated herein by reference in their entireties.

### BACKGROUND AND TECHNICAL FIELD OF THE INVENTION

The present invention relates to hinges used on vehicles, such as automobiles, and more particularly to multi-component hinges for mounting a door to a vehicle, such as a rear lift gate or the like to a vehicle.

Modern automobiles include a number of different types of hinges. Some hinges are used to mount the doors to the body of the vehicle, others to mount the trunk lid or deck lid to the vehicle body, others to pivotably support the rear door or lift gate of a vehicle at the rear of the vehicle body (such as, for example, the body of a minivan or sport utility vehicle or the like), and others are used to mount the hood to the vehicle body.

Due to competitive market forces, automobile manufactures continually seek to decrease the manufacturing costs of virtually all automobile components, including vehicle hinges. However, as the weights and material thicknesses of parts are reduced, such reduction may undesirably result in a hinge of insufficient strength. In addition, the assembly or connecting together of various parts of the hinge using fasteners, such as threaded fasteners like bolts or screws, or other fasteners, such as rivets, may be difficult due to the reduced material thicknesses. To overcome such difficulties, it is known to include a threaded nut that is welded onto a component member at a fastening location. However, such a welding process adds manufacturing processes to the manufacture of the component or hinge.

Therefore, the desire exists for automobile hinges having reduced manufacturing costs, but which have sufficient structural strength and integrity and which may be securely assembled using fasteners.

### SUMMARY

The present invention provides hinges that are easier and less expensive to manufacture than conventional hinges and which may be readily and securely assembled due to the inclusion of a fastener insert that enables materials, such as stamped materials, to be efficiently and securely affixed together using fasteners. In one embodiment of the present invention, an automobile hinge construction is provided that includes a body attachment plate and a gate attachment plate that are both pivotably connected to an intermediate member. The intermediate member may be constructed to have a relatively thin wall or thickness and may be formed by stamping such that it is lighter and less expensive to manufacture relative to comparable parts. The intermediate member may also be formed in a manner that enhances the strength of the intermediate member to limit or substantially preclude bending or twisting under loads typically encountered during opening and closing of a pivotable door, gate or panel or the like. A fastener element or insert is inserted into the intermediate member and enables the intermediate member to be securely affixed to the body attachment plate using a fastener as the vehicle to which the hinge is mounted is assembled.

According to an aspect of the present invention, an automobile hinge for pivotally mounting a pivotable panel component to a vehicle body comprises a panel attachment plate adapted to be secured to a pivotable panel (such as a rear lift gate or the like) of a vehicle, a body attachment plate adapted to be secured to a vehicle body, and an intermediate member pivotally attached to the body attachment plate, and with the panel attachment plate being pivotally attached to the intermediate member. The intermediate member comprises opposite sidewalls and a center flange extending between the opposite sidewalls. The sidewalls engage the body attachment plate and the center flange is spaced from the body attachment plate when the intermediate member is pivoted toward a first position where a first portion of the intermediate member is positioned generally along the body attachment plate. The intermediate member is securable in the first position relative to the body attachment plate. The automobile hinge further comprises a fastener element adapted to being insertably affixed to the center flange of the intermediate member with a portion of the fastener element positioned within a space defined by the sidewalls, the center flange, and the body attachment plate when the intermediate member is in the first position. The fastener element is adapted to receive a fastener extended from the body attachment plate to secure the intermediate member in the first position.

According to another aspect of the present invention, an automobile hinge for pivotally mounting a pivotable panel component to a vehicle body comprises a panel attachment plate adapted to be secured to a pivotable panel of a vehicle, a body attachment plate adapted to be secured to a vehicle body, and an intermediate member pivotally attached to the body attachment plate with the panel attachment plate being pivotally attached to the intermediate member. The intermediate member comprises opposite sidewalls and a center flange extending between the opposite sidewalls with the center flange including an insert aperture. The sidewalls engage the body attachment plate with the center flange being spaced from the body attachment plate when the intermediate member is pivoted toward a first position where a first portion of the intermediate member is positioned generally along the body attachment plate. The intermediate member is securable in the first position relative to the body attachment plate. The automobile hinge further comprises a fastener element adapted to being inserted at least partially through the insert aperture, the fastener element being adapted to receive a fastener to secure the intermediate member to the body attachment plate in the first position. The fastener element comprises a flange defining a first end of the fastener element, a body extending from the flange and defining a second end opposite the flange with the body including a fastener receptacle, and at least one securing element adapted to engage the center flange such that movement of the fastener element relative to the intermediate member is limited.

According to another aspect of the present invention, a method for making an automobile hinge comprises providing a panel attachment plate adapted to be secured to a pivotable panel component of a vehicle, providing a body attachment plate adapted to be secured to a vehicle body, providing an intermediate member by stamping a metallic sheet, and providing a fastener element adapted to receive a fastener. The stamped intermediate member has first and second leg portions extending at an angle to one another, the first and second leg portions comprising a generally U-shaped cross section and having opposite sidewalls and a center flange extending between the opposite sidewalls with the center flange including an insert aperture on the first leg portion. The fastener element is inserted at least partially through the insert aperture such that a portion of the fastener element is positioned between the opposite sidewalls. The intermediate member is pivotally attached to the body attachment plate generally at a junction of the first and second leg portions such that the intermediate member is pivotable toward a first position where the first leg portion is positioned generally along the body attachment plate. The panel attachment plate is pivotally attached to the intermediate member with the panel attachment plate being pivotally attached to the intermediate member at an end portion of the second leg portion. The intermediate member is pivoted into the first position and secured to the body attachment plate using a fastener such that the intermediate member is generally fixedly secured to the body attachment plate in the first position.

Therefore, the present invention provides a hinge or hinge component for a vehicle or automobile that includes a fastener element or insert adapted for use with a component member, such as an intermediate member of a hinge, which is to be secured to another component and has a thickness less than the length of the body of the fastener insert. The fastener element is configured to securely mate with the intermediate member and, when so mated, resists movement relative to the intermediate member. In such an application, the fastener element provides significantly greater contact area or attachment length for a fastener as compared to securing a fastener directly to the intermediate member, thus providing a more secure joint. The fastener element thereby enables the automobile hinge to be of simpler construction and materials, such as a stamped metallic material, while being sufficiently fixedly securable to another component member. For example, the intermediate member may be formed of a stamped metallic material having a generally U-shaped cross section that may form a cavity, channel, or hollow portion with respect to a body attachment plate component of the hinge, which may also be formed by stamping, when leg portions of the intermediate member are pivoted to extend along the body attachment plate.

These and other objects, advantages, purposes and features of the present invention will be apparent upon review of the specification in conjunction with the drawings.

### BRIEF DESCRIPTION OF THE DRAWINGS

FIG. 1 is a rear perspective view of a vehicle incorporating a hinge in accordance with the present invention;

FIG. 2 is a perspective view of a hinge of the present invention, with the hinge shown in an extended position and a fastener insert and fastener shown in an exploded relation to the hinge;

FIG. 3 is a perspective view of the hinge of FIG. 2 with the intermediate member in a retracted position;

FIG. 4 is a perspective view of the hinge of FIGS. 2 and 3, shown with a fastener insert of the present invention inserted into the intermediate member;

FIG. 5 is a front perspective view of the hinge of FIG. 4, with the intermediate member shown in engagement with a body attachment plate;

FIG. 6 is a sectional view of a fastener insert in engagement with an intermediate member in accordance with the present invention;

FIG. 7 is a side elevation of the fastener insert of the present invention;

FIG. 8 is a sectional view of the fastener insert taken along the line VIII-VIII of FIG. 7;

FIG. 9 is a plan view of the fastener insert of FIG. 7;

FIG. 10 is a sectional view of the fastener insert taken along the line X-X of FIG. 7;

FIG. 11 is a perspective view of another hinge in accordance with the present invention;

FIG. 12 is a perspective view of the underside of the intermediate member of the hinge of FIG. 11; and

FIG. 13 is a perspective view of the body attachment plate of the hinge of FIG. 11.

### DESCRIPTION OF THE PREFERRED EMBODIMENTS

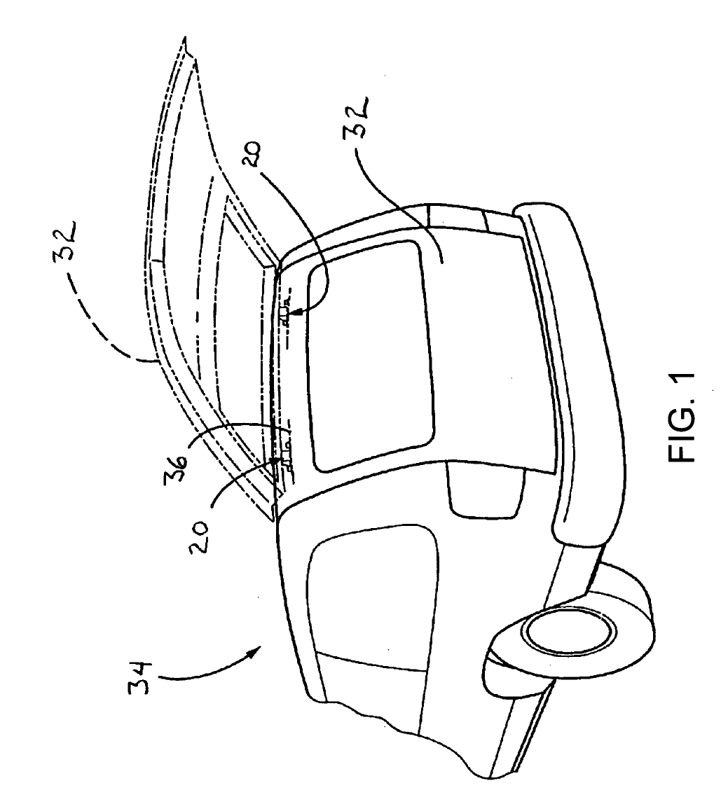

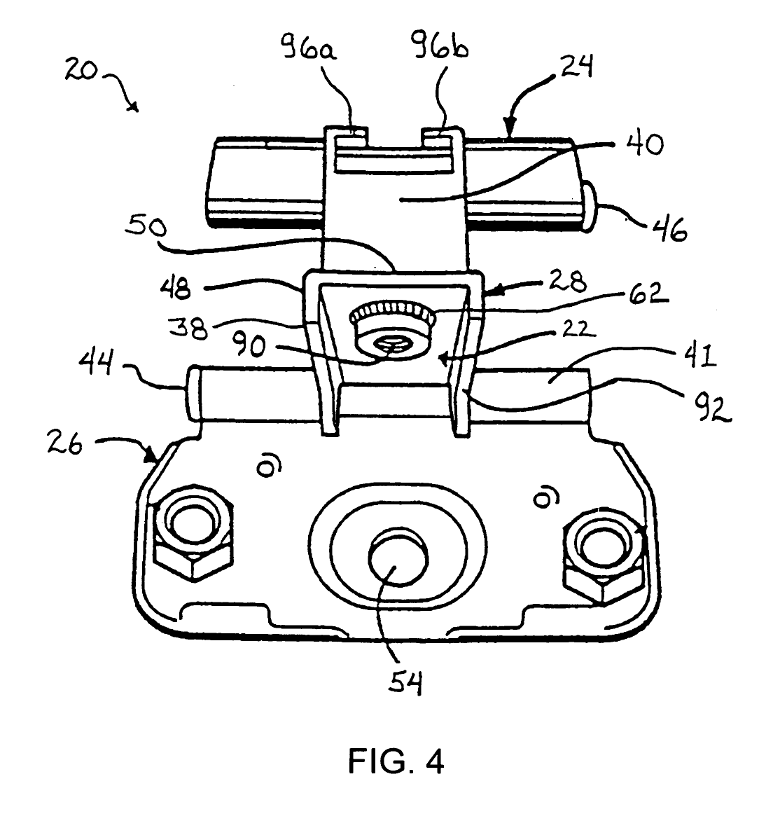

The present invention will now be described with reference to the accompanying figures, wherein the numbered elements in the following written description correspond to like-numbered elements in the figures. A hinge 20 incorporating a fastener element or insert 22 to secure certain of the components of the hinge 20 together is depicted in FIGS. 1-5. Hinge 20 is adapted for use in mounting a pivotable component of a vehicle to the vehicle body and includes a gate or panel attachment plate or portion 24, a vehicle body attachment plate or portion 26, and an intermediate member 28, such as described in U.S. patent application Ser. No. 10/650,628, filed Aug. 28, 2003, which is hereby incorporated herein by reference. Fastener insert 22 provides a fastener receptacle or threaded passageway 90 (FIG. 4) that extends from a central or center flange portion or wall 50 of intermediate member 28 toward the plate 26 when intermediate member 28 is pivoted toward plate 26. During assembly of the vehicle, intermediate member 28 and body attachment plate 26 are secured together using fastener insert 22 and a fastener 30. Fastener insert 22 enables intermediate member 28 and body attachment plate 26 to be readily secured together in a more secure manner as compared to engagement of a fastener directly with the center flange or wall 50 of intermediate member 28 due to the difficulty in forming threads or a sufficient number of threads in intermediate member 28 to withstand the torque and forces necessary to assemble hinge 20.

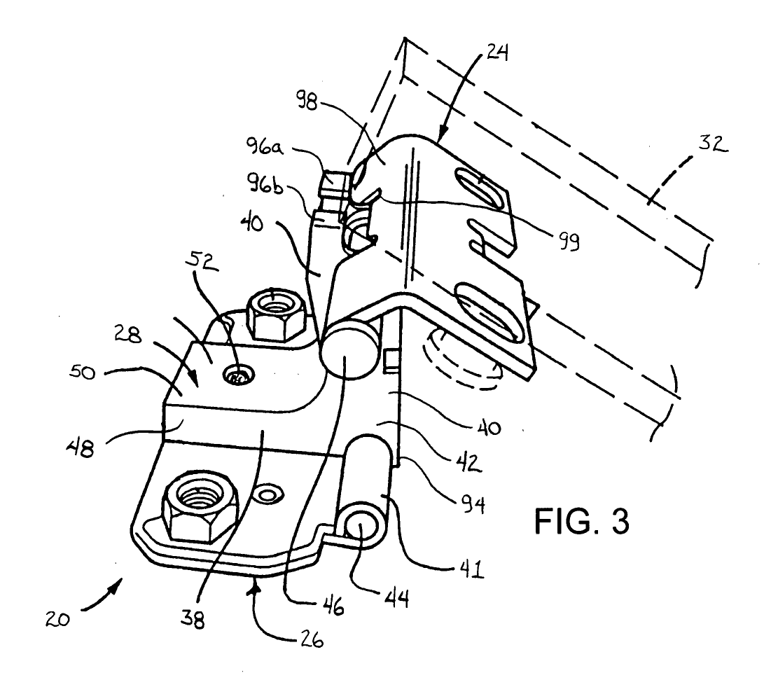

As can be seen with reference to FIGS. 1 and 3, gate attachment plate 24 is attached to a pivotable panel or gate 32 (such as a rear door or lift gate or hatch-back or other pivotable panel or the like) of a vehicle 34, while body attachment plate 26 is attached to a body or roof portion 36 of vehicle 34. Both gate attachment plate 24 and vehicle body attachment plate 26 are pivotably attached to intermediate member 28, which allows the gate attachment plate 24 to pivot relative to the intermediate member 28, while also allowing the intermediate member 28 to pivot relative to the body attachment plate 26. The ability of gate attachment plate 24, body attachment plate 26, and intermediate member 28 to pivot with respect to each other is advantageous during assembly of vehicle 34 as it enables, for example, gate 32 to be conveniently positioned during painting operations. As noted above, intermediate member 28 and body attachment plate 26 are secured together using fastener insert 22 and fastener 30 when assembly of vehicle 34 is complete such that gate 32 may operate as intended for a consumer.

Intermediate member 28 is preferably made from stamped metal, preferably stamped steel or the like, and may be stamped from a single piece of sheet metal. Similarly, gate attachment plate 24 and body attachment plate 26 may also be constructed of stamped metallic material. Intermediate member 28 comprises an angled or bent or generally L-shaped member having a first or body plate leg or portion 38 and a second or gate plate leg or portion 40 arranged at an angle to one another. Intermediate member 28 is pivotably mounted at a hinge portion 41 of body attachment plate 26 at a junction 42 of the legs 38, 40 via a pivot pin 44. Gate attachment plate 24 is similarly pivotably mounted to an outer end portion of leg 40 via a pivot pin 46.

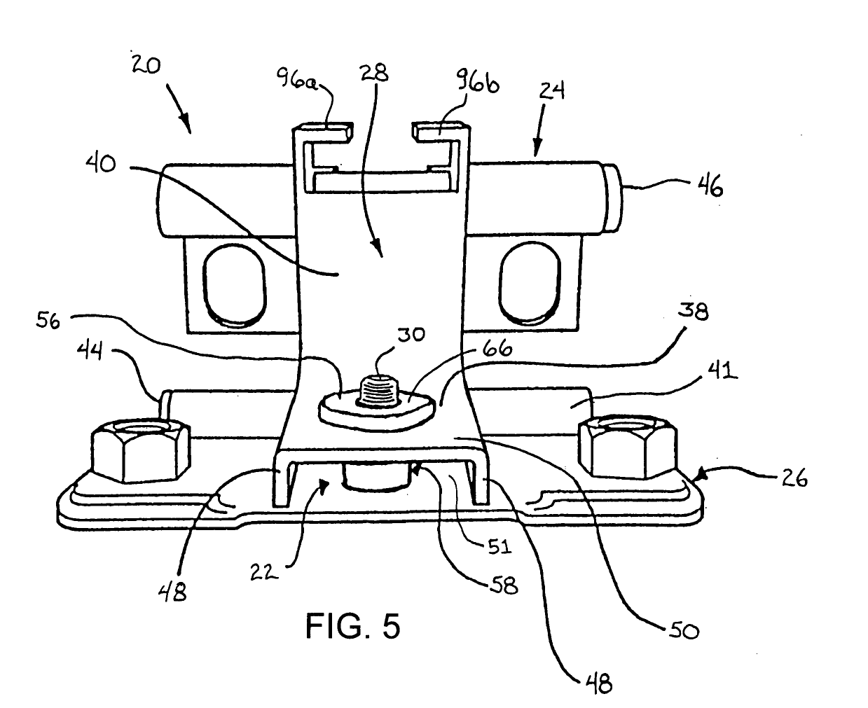

Intermediate member 28 includes a pair of opposite sidewalls 48 and a central wall or flange portion 50 extending along and generally between the sidewalls 48. The arrangement of the central flange 50 and sidewalls 48 provides enhanced structural rigidity and strength to intermediate member 28, in order to limit or substantially preclude twisting or bending of the intermediate member 28 during use of hinge 20. The intermediate member 28 thus has a generally U-shaped cross section along both legs 38, 40 and thus along substantially the entire length of the intermediate members. As can be seen in FIGS. 4-6, body plate leg 38 defines a generally inverted U-shaped member relative to body attachment plate 26. Accordingly, when intermediate member 28 is pivoted relative to body attachment plate 26 such that body plate leg 38 is positioned generally along and adjacent to and in engagement with body attachment plate 26, the opposite sidewalls 48 along leg or portion 38 engage the surface of body attachment plate 26, with the central flange 50 spaced from the plate 26. When so pivoted, fastener element or insert 22 extends from center flange 50 toward plate 26 and is positioned so that the fastener receptacle 64 (described in detail below) is within the cavity, hollow portion, or channel 51 defined by side walls 48, center flange 50 and plate 26 (as can be seen in FIG. 5), and may substantially or entirely span the distance between flange 50 and plate 26. The fastener insert or element 22 is thus attached to the center flange 50 of the intermediate member 28 and the fastener receptacle 64 is located within the channel or hollow space 51 formed by the sidewalls 48 and center flange 50 of the first leg 38, and further defined by the body attachment plate 26 when the intermediate member 50 is pivoted to the secured position.

Although shown and described with the U-shaped leg 38 having its sides 48 along the body attachment plate 26 and with the center flange 50 spaced from the body attachment plate 26, it is envisioned that the U-shaped intermediate member may be formed with at least the first leg portion inverted (as compared to first leg portion 38 of intermediate member 28 described above). Thus, the central flange portion of the inverted first leg portion may extend along or engage the body attachment plate 26 when the intermediate member is pivoted generally along and adjacent to the body attachment plate 26. The opposite sidewalls of the inverted first leg portion may extend upwardly or outwardly relative to the body attachment plate 26, and a fastener element or insert may be installed or attached to the central flange and may extend from the center flange between the opposite sidewalls so as to locate the fastener receptacle in the cavity or channel defined by the central flange and the sidewalls.

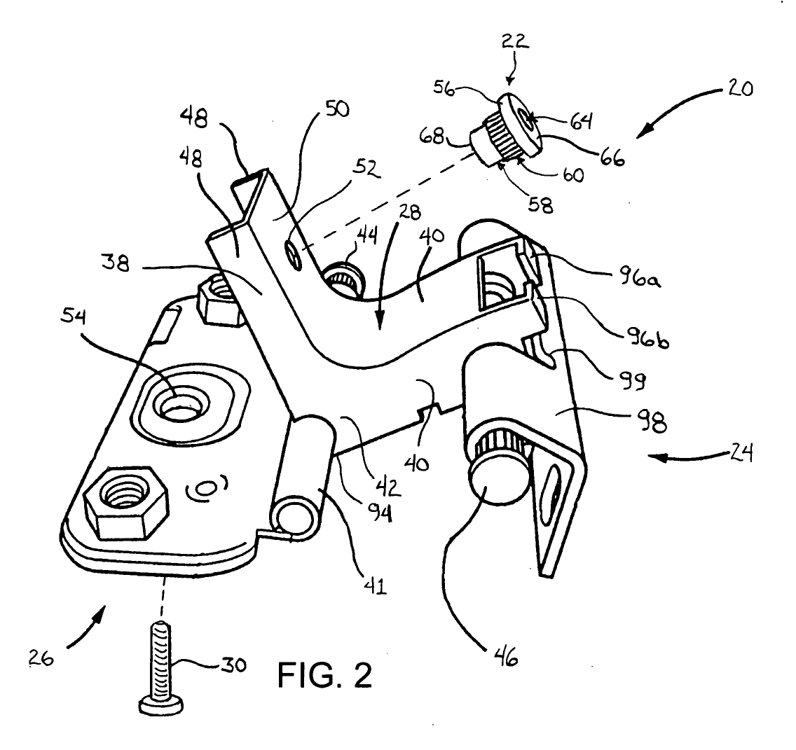

In the illustrated embodiment, intermediate member 28 includes an insert hole or aperture or opening 52 (FIGS. 2 and 3) positioned through central flange 50, and body attachment plate 26 includes an opening 54 therethrough. Insert hole 52 and opening 54 are positioned relative to one another such that they substantially align when intermediate member 28 is pivoted to its secured position, where the sidewalls 48 of leg 38 of contact body attachment plate 26. Insert hole 52 is adapted to receive fastener insert 22 so that the fastener receptacle of fastener insert 22 is substantially aligned with the opening 54 in body attachment plate 26 when intermediate member 28 is pivoted in the manner described above to aid in securing intermediate member 28 to body attachment plate 26, as discussed below.

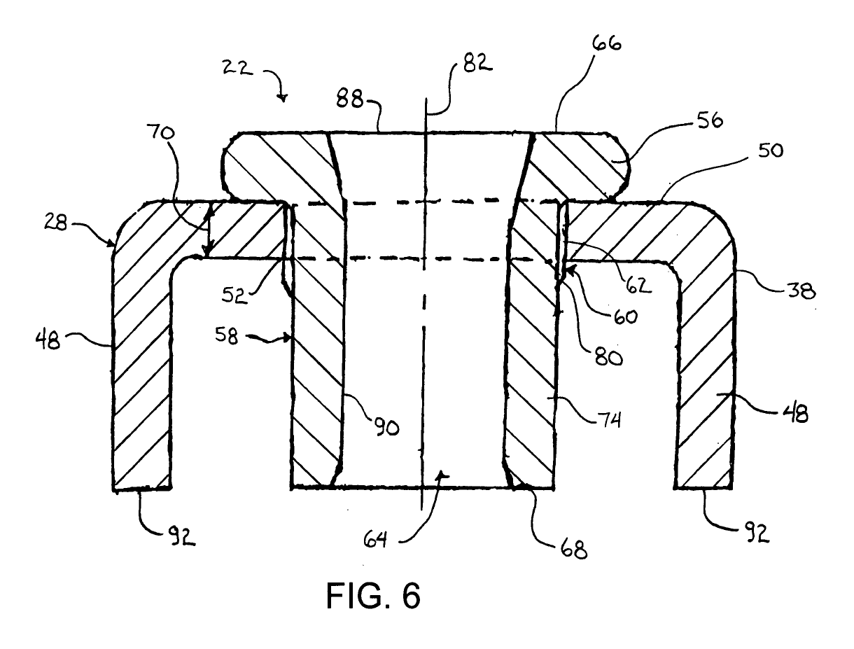

Referring now to FIGS. 6-10, fastener insert 22 may be constructed as an internally threaded member and includes a shoulder or flange 56, a receptacle member or body 58, and multiple securing members or elements 60. In the illustrated embodiment securing elements 60 comprise a series of protrusions or knurls 62 around the outer surface of body 58 and proximate to flange 56. Fastener insert 22 also includes a fastener receptacle or passageway 64 that extends at least partially between first and second ends 66, 68 within body 58. Fastener receptacle 64 may comprise a threaded passageway at least partially through body 58 that is adapted to receive an externally threaded fastener 30 (FIG. 2). Fastener insert 22 is adapted to be inserted through central flange portion 50 of intermediate member 28, which has a thickness 70 (FIG. 6), that is less than the length 72 (FIG. 8) of body 58. In such an application, fastener insert 22 provides significantly greater contact area or attachment length for a fastener as compared to securing a fastener directly to central flange portion 50, thus providing a secure joint. Fastener insert 22 is thereby advantageous in that it enables intermediate member 28 to have a relatively thinner or reduced thickness while being sufficiently fixedly securable to body attachment plate 26.

As shown (in FIG. 6), body 58 of fastener insert 22 is generally cylindrical in form and is adapted to be inserted into insert aperture 52 on central flange portion 50 of intermediate member 28. Body 58 includes a guide portion or clearance portion 74 that may not include knurls 62. The diameter 76 of clearance portion 74 is sized to provide a slip or clearance fit within hole 52, but may alternatively provide a press fit engagement with the walls of hole 52. Although body 58 is shown and described as being generally cylindrical, it should be understood that a body may be constructed to have alternative geometric cross-sectional forms, such as rectangular, triangular, or oval shapes or forms, and still function as intended and without affecting the scope of the present invention.

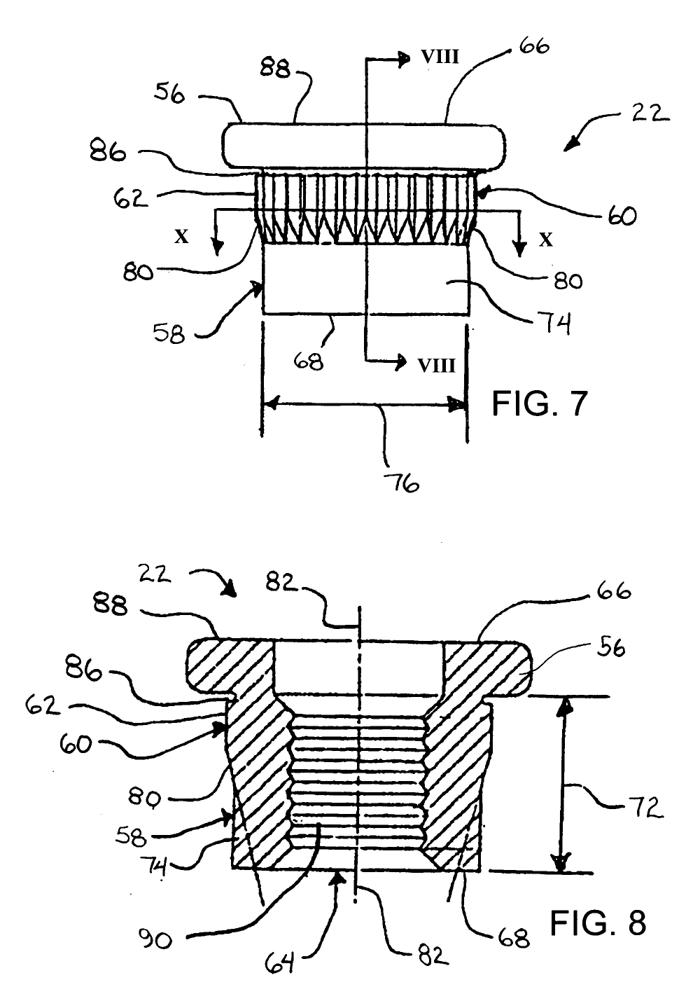

Knurls 62 are located on or disposed or established at body 58 between flange 56 and clearance portion 74. As shown in FIG. 10, knurls 62 may comprise a circumferential series of projections or serrations around the exterior surface of body 58 and axially aligned with body 58. The circumferential knurls 62 thus form an outer or major diameter 78, as measured about the outer peaks of 180 degree opposing knurls 62. As shown in FIGS. 7 and 8, the outer or major diameter 78 is greater than the outer diameter 76 of clearance portion 74. Optionally, knurls 62 may include a chamfer or angled lead edge 80 that extends from the outer diameter 76 of clearance portion 74 to the outer diameter 78 of knurls 62. As described below, the angled lead edge 80 of knurls 62 aids in the insertion of fastener insert 22 into insert aperture 52 of central flange portion 50.

Knurls 62 are constructed to have a slightly larger outer diameter 78 than the diameter of insert aperture 52 of central flange portion 50 such that fastener insert 22 provides a press fit engagement with intermediate member 28 when substantially or fully inserted into insert aperture 52. When fastener insert 22 is pressed into central flange portion 50 (such as when the fastener insert is pressed into the central flange until the shoulder or flange 66 of fastener insert 22 approaches or engages the central flange 50 of intermediate member 28), knurls 62 may plastically deform the circumferential edge or wall of insert aperture 52 (and/or the knurls themselves may plastically deform) such that fastener insert 22 becomes substantially mechanically locked or engaged with intermediate member 28. Clearance portion 74 and angled lead edge 80 of fastener insert 22 thus help to align insert 22 and initiate the deformation of the edge of insert aperture 52 during insertion.

The substantially tight engagement of knurls 62 and the edge of insert aperture 52 not only functions to retain fastener insert 22 to intermediate member 28, but the axial alignment of knurls 62 relative to body 58 are well adapted to limit or substantially preclude rotation of fastener insert 22 about the longitudinal axis 82 of body 58 relative to intermediate member 28. Thus, when a fastener 30 is inserted into fastener receptacle 64 and tightened to secure intermediate member 28 to body attachment plate 26, as described below, an increased or substantial rotational torque may be placed on fastener insert 22. The ability of fastener insert 22 to resist rotation within insert aperture 52 of intermediate member 28 due to knurls 62, therefore, enables intermediate member 28 to be firmly secured to body attachment plate 26.

Although disclosed as a series of circumferentially oriented knurls 62 surrounding body 58, it should be appreciated that alternatively constructed securing or retaining or attaching elements or protrusion or knurls could be located on a fastener insert while still allowing the fastener insert to function as intended. For example, alternative securing elements could be formed as generally square or oval-shaped (or any other suitable shape and preferably non-circular shape) lugs. Furthermore, fewer securing or retaining elements could be utilized or could be formed to not encompass the entire circumference of the body. The securing or retaining elements could also be alternatively located on a fastener insert. For example the securing or retaining elements could be located proximate the second end or could extend the entire length of the body. Still further, alternative or additional securing or retaining elements could be located the flange of the fastener insert with such securing or retaining elements being adapted to engage the center flange portion of the intermediate member when the fastener insert is inserted therein. Optionally, the fastener element or insert may be also or otherwise welded or adhered to the center flange to further retain and secure the fastener element or insert to the intermediate member.

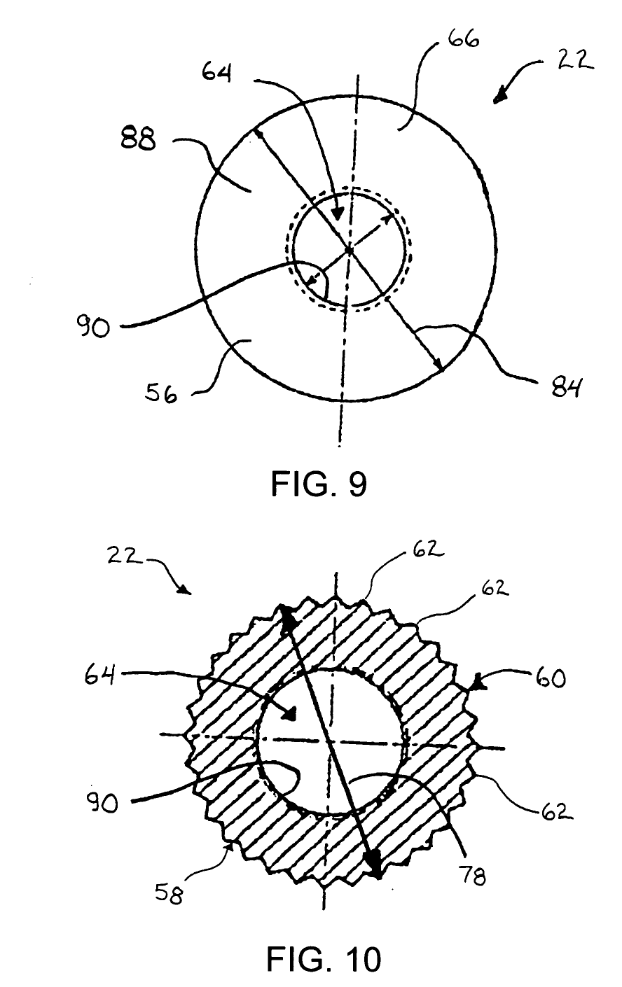

In the illustrated embodiment, flange 56 of fastener insert 22 is integrally formed with body 58. As shown in FIGS. 7 and 8, flange 56 is oriented substantially perpendicular to the longitudinal axis 82 defined by body 58. Flange 56 is constructed to have a diameter 84 (FIG. 9) that is greater than the diameter 76 (FIG. 7) of body 58 and greater than the major diameter 78 of knurls 62, such that flange 56 functions as a stop when fastener insert 22 is inserted into hole 52 of intermediate member 28, thereby preventing fastener insert 22 from passing through hole 52. Flange 56 also functions to impart a clamp load to intermediate member 28 when a fastener 30 is inserted into fastener receptacle 64 from second end 68 and used to secure intermediate member 28 to body attachment plate 26. As also shown in FIGS. 7 and 8, knurls 62 may be located proximate flange 56 with a relief or gap 86 separating knurls 62 from flange 56, with gap 76 functioning as a stress relief at the transition from body 58 to flange 56.

Although flange 56 is shown and described as having a generally perpendicular orientation relative to body 58, it should be appreciated that flange 56 and body 58 could be oriented differently with respect to each other while still functioning as intended, without affecting the scope of the present invention. For example, if an intermediate member were constructed with an insert aperture that did not extend perpendicularly relative to a surface defined by the intermediate member, the flange could be correspondingly angled or oriented relative to the body such that the flange would still substantially contact the surface of the intermediate member when inserted therein. Additionally, although flange 56 is disclosed as having a generally flat upper surface 88, the upper surface of the flange could be constructed to include protuberances or cavities. Such protuberances or cavities, for example, could be adapted to mate with tooling or the like that may be used to insert or press a fastener insert into an insert aperture of an intermediate member.

As shown in FIGS. 8 and 9, fastener receptacle 64 of fastener insert 22 may comprise a threaded through hole or passageway 90 adapted to receive a threaded fastener 30, such as a bolt or screw or the like. For a body 58 of a given diameter, variously sized threaded holes 90 may be constructed in order to accommodate the various categories of standard size threaded fasteners that may be used to secure two or more components together. During the manufacturing processing of the fastener inserts, numerous substantially identical fastener inserts, or blanks, may be produced prior to forming the fastener receptacle. From such blanks, various fastener inserts can be independently formed into finished fastener inserts having fastener receptacles of the selected or appropriate sized threaded holes based on the characteristics of the intended male fastener or bolt or screw, such as thread type, pitch, and diameter of the fastener. Thus, depending on the particular application of the fastener insert and hinge, a selected or appropriate sized fastener may be used to secure the components together. As such, the intermediate members 28 of the particular hinges to be secured to vehicles may be formed with standard diameter holes 52 that are sized to form a press fit with the fastener inserts, as described above, with the fastener inserts being selected based on the size and pitch of fastener receptacles required to mate with the particular size and pitch of threaded fasteners to be used in the particular application.

Although fastener receptacle 64 is shown and described above as being formed as a threaded through passageway 90, it should be appreciated that fastener receptacle 64 may alternatively be formed as a blind hole or partial hole or passageway. A fastener receptacle, for instance, could be blocked or covered by the flange at the first end. Furthermore, a fastener receptacle may also be constructed to receive alternatively styled fasteners. For example, a fastener receptacle could be constructed to include one or more slots or grooves that are adapted to receive a fastener having one or more prongs or pins, where the pins on such a fastener would mate within the grooves of the fastener receptacle. A fastener insert may also be constructed to receive a rivet or plug or the like and still function as intended within the scope of the present invention. Other fastening or attachment elements or means may also be implemented, without affecting the scope of the present invention.

Although fastener insert 22 is illustrated as including an internally threaded body 58 adapted to receive an externally threaded fastener 30, it should also be appreciated that alternative arrangements of externally and internally threaded members or fastener elements or inserts and fasteners may be utilized within the scope of the present invention. For example, a fastener insert could be constructed to include external threads on a body portion with the fastener insert still including a securing element adapted to impede or limit relative movement of the fastener insert when inserted into, for example, the intermediate member. In such case, the fastener may than include internal threads adapted to engage the external threads of the fastener insert.

In the illustrated embodiment, fastener element or insert 22 is constructed of a metallic material and may be plated for corrosion resistance or for appearance considerations. Alternatively, depending upon the strength requirements of a given application and/or the material of an intermediate member, a fastener insert may be constructed of a polymeric material or other suitable materials and still function as intended, without affecting the scope of the present invention.

Thus, insert hole 52 of intermediate member is adapted to receive fastener insert 22 in the press fit manner described above with fastener insert 22 being pressed into insert hole 52 such that flange 56 approaches and/or contacts/engages central flange 50 while body 58 extends into the area or channel defined by the U-shaped leg 38 and between opposite sidewalls 48. When fastener insert 22 is so installed on hinge 20, a fastener, such as a threaded male fastener 30 or bolt or screw or the like, may be used to secure intermediate member 28 to vehicle body attachment plate 26 in a non-pivoting manner. In practice, this may be accomplished by inserting fastener 30 through opening 54 in body attachment plate 26 and threading the fastener 30 into engagement with fastener receptacle 64 of fastener insert 22. As the fastener 30 is tightened within fastener insert 22, the leg 38 of intermediate member 28 is tightly secured to body attachment plate 26.

In the illustrated embodiment, body 58 of fastener insert 22, when inserted through insert hole 52, extends beyond central flange 50 such that second end 68 of fastener insert 22 will be approximately aligned in a generally planar orientation with the bottoms or ends 92 of sidewalls 48. It should be appreciated, however, that body 58 may be of longer or shorter lengths 72 relative to sidewalls 48 such that less or more clamp load may be imparted to intermediate member 28 via tightening of the fastener (which may function to draw the fastener insert toward the body attachment plate), without affecting the scope of the present invention.

As should be understood, the length of threaded engagement of fastener 30 within fastener receptacle 64 will be greater than the thickness 70 of central flange 50. As such, intermediate member 28 may be more securely affixed to body attachment plate 26 as compared to providing a limited number of threads within insert hole 52 and securing intermediate member 28 to body attachment plate 26 by directly threading a fastener 30 into such a threaded insert hole. Therefore, use of fastener insert 22 is beneficial in enabling the use of a stamped metallic hinge 20 that may be constructed and assembled to have sufficient structural rigidity to be used in an automotive vehicle application. The fastener insert 22 is suitable for use in attaching other components of other hinges or of other devices or structures, and may be implemented in such other hinges or other devices or structures without affecting the scope of the present invention.

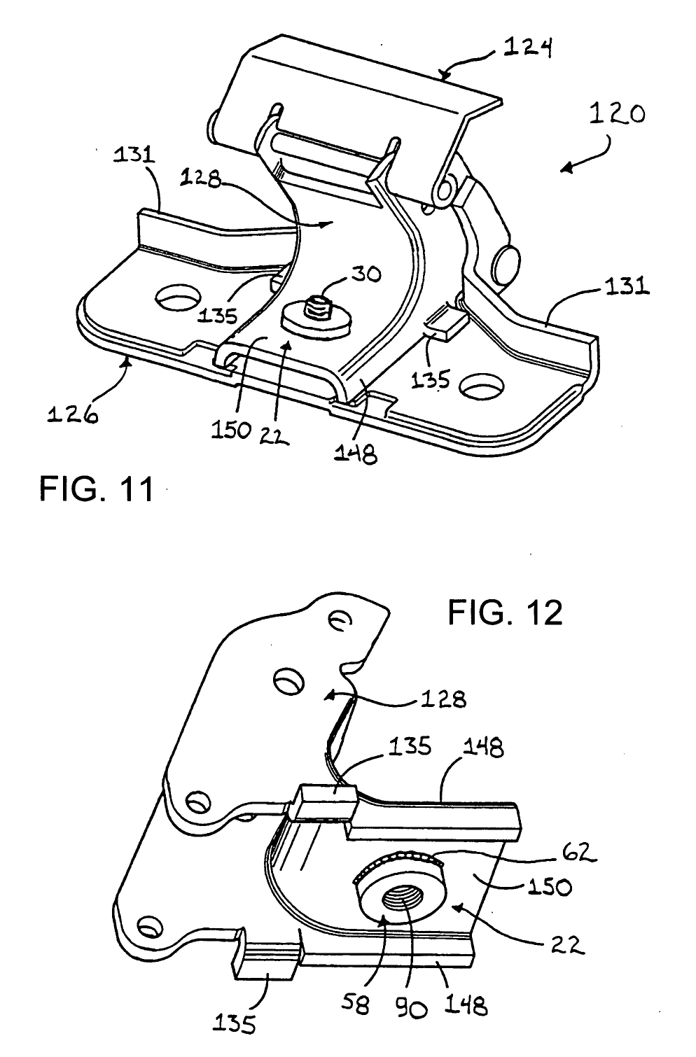

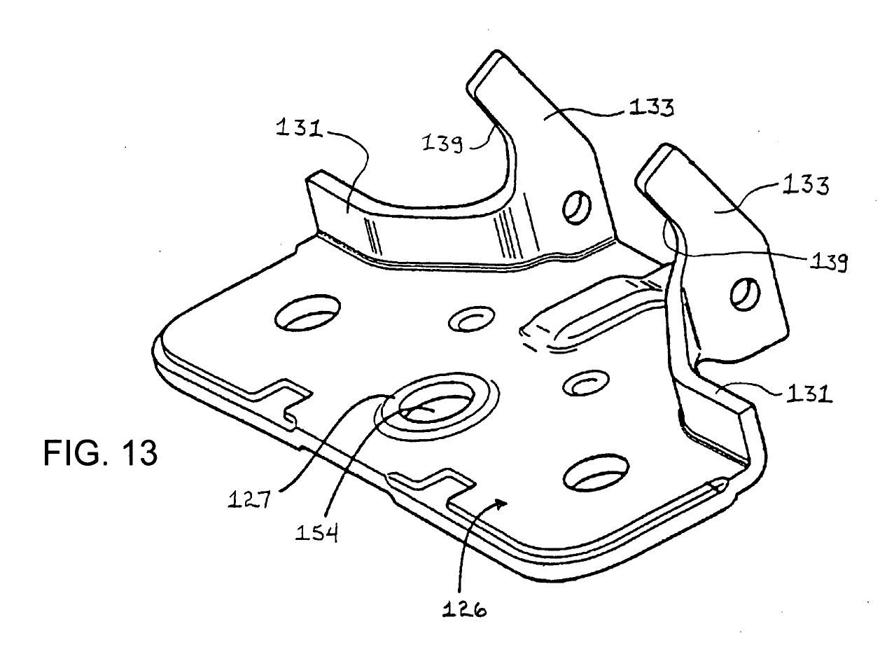

Referring now to FIGS. 11-13, an automobile hinge 120 includes a body attachment plate 126 and a gate or panel attachment plate 124 and an intermediate member 128 pivotably mounted to body attachment plate 126 and gate attachment plate 124. Hinge 120 is substantially similar to hinge 20, discussed above, such that a detailed discussion of the hinge will not be repeated herein. The similar or common components or features of the hinge 120 are referenced with similar reference numbers in FIGS. 14-16, but with 100 added to each reference number. As described above with respect to hinge 20, hinge 120 utilizes a fastener element or insert 22 to aid in securing intermediate member 128 to body attachment plate 126.

In the illustrated embodiment, body attachment plate 126 includes an upwardly protruding portion 127 around the opening 154, such that second end 68 of fastener insert 22 may contact the upwardly extending portion 127 when secured together in the above described manner. Upwardly protruding portion 127 thus functions to aid in both substantially positively positioning the intermediate member 128 relative to body attachment plate 126 and aligning fastener receptacle 64 with opening 154.

Body attachment plate 126 includes two raised wall or flange portions 131 extending generally vertically upwardly from and at least partially along an edge or portion of body attachment plate 126. Flange 131 extends along the rear edge portion and extends at an angle to (such as generally orthogonal or transverse to) the rear edge or edge portion of the plate portion and generally rearwardly to define spaced apart and opposed hinge portions 133, such as described in U.S. patent application Ser. No. 10/650,628, filed Aug. 28, 2003, and published on Mar. 25, 2004 as U.S. Publication No. US-2004-0055112-A1, which is hereby incorporated herein by reference in its entirety.

Body attachment plate 126 may be positioned at a rearward end of the body or roof portion of the vehicle such that the hinge portions 133 of body attachment plate 126 may overhang or extend from the rearward end of the body or roof portion and, thus, may be unsupported by the body or roof portion of the vehicle. When so mounted, the generally rearwardly extending raised hinge portions 133 and flange portions 131 provide enhanced structural rigidity to the body attachment plate 126 to limit or substantially preclude downward flexing or bending of the hinge portion and/or plate portion during pivotal movement of the intermediate member 128 (and the gate attachment plate and gate) relative to the body attachment plate 126 and/or pivotal movement of the gate attachment plate 124 (and gate) relative to the intermediate member 128.

The hinge of the present invention may also include various elements or features for inhibiting or limiting movement of the body attachment plate and the gate attachment plate relative to the intermediate member. For example, the intermediate member 28 may include a stop member or members 94 (FIGS. 2 and 3) at or near the junction 42 of the leg portions 38, 40 for limiting pivotal movement of intermediate member 28 relative to body attachment plate 26. Intermediate member 28 may also include a stop member or members 96a, 96b at an end of leg portion 40 to limit pivotal movement of gate attachment plate 24 relative to intermediate member 28, with a hinge mounting portion 98 of gate attachment plate 24 including a stop portion 99 for engaging the stop members 96a, 96b of intermediate member 28.

The stop portions 96a, 96b may be adjusted or cut or trimmed to adjust the stop portions to accommodate different degrees of pivotal movement of gate attachment plate 24 relative to intermediate member 28. The stop members 96a, 96b thus may limit how far the vehicle gate can be opened by engaging the stop portions 99 of gate attachment plate 24 as the gate attachment plate 24 (and the lift gate) pivot to the desired fully opened position. Intermediate member 28 thus may comprise a common part or common parts for different vehicles or vehicle lines, whereby the stop members 96a, 96b may be adjusted or trimmed, such as by a punch or stamping process, a desired amount to adapt the intermediate member 28 to each particular application, depending on the desired amount of pivotal movement of the gate or/and gate attachment plate 24.

Optionally, and with reference to FIGS. 11-13, the intermediate member 128 may include a pair of stop members 135 which extend outwardly from sidewalls 148 for engaging stop members 139 of body attachment plate 26. The contacting of stop members 139 by stop members 135 of intermediate member 128 thereby limits pivotal movement of intermediate member 128 relative to body attachment plate 126, such as when the intermediate member 128 is pivoted relative to the body attachment plate 126 for the paint process at the vehicle assembly plant, and before the intermediate member 128 is secured to the body attachment plate 126 using fastener insert 20.

Although fastener insert 20 is illustrated as being inserted through intermediate members 28, 128 in the above discussed illustrated embodiments, it should be appreciated that the fastener insert may be alternatively inserted or affixed to an automobile hinge within the scope of the present invention. For example, a fastener insert may be inserted through a body attachment plate where the fastener receiving end of the fastener insert may extend between the sidewalls of the leg of the intermediate member when the intermediate member is pivoted into the first position adjacent the body attachment plate. Thus, a fastener may be inserted through the center flange of the intermediate member and received in the fastener receiving end or fastener receptacle of the fastener insert to secure the intermediate member in the first position. Optionally, the fastener element or insert may otherwise be attached to or located at the center flange of the intermediate member so as to extend between the intermediate member and body attachment plate without affecting the scope of the present invention. For example, the fastener element may be integrally formed as part of the outer flange, such as via a stamping process during the formation of the intermediate member.

Upon insertion of fastener element 22 into aperture 52 of center flange 50 in the manner described above, body attachment plate 26 of hinge 20 may be mounted or secured to the body portion 36 of a vehicle 34, such as a rear portion of a roof of the vehicle, as shown in FIG. 1. The gate attachment plate 24 may be mounted or secured to the lift gate or tail gate 32 of the vehicle 34, such that the gate 32 may be pivotally mounted to the vehicle 34 and pivoted about the pivot pin 46 between gate attachment plate 24 and intermediate member 28. Although shown and described as pivotally mounting a lift gate or tail gate to a vehicle body, the hinge of the present invention may be equally suitable for mounting other pivotable doors or panels (such as, for example, a window, a deck lid, a hood, a door or the like) to a vehicle body, without affecting the scope of the present invention.

After the gate 32 and hinge 20 are installed to the vehicle body 36, intermediate member 28 (and gate attachment plate 24 and gate 32) may pivot about the pivot pin 44 with respect to body attachment plate 24 into an extended position (FIGS. 2 and 4). Such pivotal movement of the hinge 20 may be desired during the manufacture of the vehicle 34, such as during the painting of the vehicle 34 on the vehicle assembly line. In the extended position, more clearance is provided to ensure that paint is received over all of the components of hinge 20, as well as over all of the external surfaces of the vehicle body 36 and gate 32. First stop member or members 94 (FIGS. 2 and 3) may limit the pivoting of the intermediate member 28 with respect to vehicle body attachment plate 26 by abutting against a portion of body attachment plate 26.

After painting, intermediate member 28 may be pivoted back, such that sidewalls 48 of leg portion 38 are in contact with body attachment plate 26. Intermediate member 28 may then be substantially fixedly secured to body attachment plate 26 using fastener 30. Fastener 30 is inserted upwardly through aligned opening or hole 54 (FIG. 2) in body attachment plate 26 and threadably engaged with threaded hole 90 of fastener receptacle 64 of fastener element 22. When fastener 30 is so engaged with fastener element 22, sidewalls 48 of leg portion 38 and end 68 of fastener element 22 may be substantially fixedly engaged with or retained against body attachment plate 26, as shown in FIG. 26. Thereafter, hinge 20 may pivot only about pivot pin 46 at the junction between intermediate member 28 and gate attachment plate 24.

Therefore, the automobile hinge of the present invention includes a fastener element or insert at an intermediate member of the hinge, with the intermediate member being pivotable and securable to a body attachment plate of the hinge via a fastener engaging the fastener element. The fastener element is able to securely engage the intermediate member and, when so engaged, resists movement relative to the intermediate member. In such an application, the fastener element provides significantly greater contact area or attachment length for a fastener as compared to securing a fastener directly to the center flange of the intermediate member, thus providing a more secure joint. The fastener element thereby enables the automobile hinge to have an intermediate member constructed with reduced wall thicknesses, such as being stamped of a metallic material, while being sufficiently fixedly securable to another component member, such as a body attachment plate component of the hinge. The stamped component or components of the hinge thus are substantially strong and structurally rigid to withstand the forces encountered in opening and closing a pivotable panel, such as a tailgate or lift gate or hatchback, or the like, of a vehicle.

The above is a description of the preferred embodiments. One skilled in the art will recognize that changes and modifications may be made without departing from the spirit of the disclosed invention, the scope of which is to be determined by the claims which follow and the breadth of interpretation that the law allows.

The embodiments of the invention in which we claim an exclusive property right or privilege are defined as follows:

1. An automobile hinge for pivotally mounting a pivotable panel component to a vehicle body, said automobile hinge comprising:
a panel attachment plate adapted to be secured to a pivotable panel of a vehicle;
a body attachment plate adapted to be secured to a vehicle body;
an intermediate member pivotally attached to said body attachment plate, said panel attachment plate being pivotally attached to said intermediate member, said intermediate member having a generally U-shaped cross section and comprising opposite sidewalls and a center flange extending between said opposite sidewalls, said intermediate member comprising a first portion and a second portion arranged at an angle relative to one another, said sidewalls of the first portion engaging said body attachment plate with said center flange being spaced from said body attachment plate when said intermediate member is pivoted toward a first position where said first portion of said intermediate member is positioned generally along said body attachment plate, said intermediate member being securable in said first position relative to said body attachment plate; and
a fastener element at said center flange of said intermediate member with a portion of said fastener element positioned within a space defined by said sidewalls, said center flange, and said body attachment plate when said intermediate member is in said first position, said fastener element adapted to receive a fastener extending from said body attachment plate to secure said intermediate member in said first position.

2. The automobile hinge of claim 1, wherein said intermediate member is pivotally attached to said body attachment plate at a junction of said first and second portions.

3. The automobile hinge of claim 2, wherein said panel attachment plate is pivotally attached to said intermediate member at an end of said second portion opposite said junction of said first and second portions.

4. The automobile hinge of claim 1, wherein said fastener element extends from said center flange and at least substantially spans a gap between said center flange and said body attachment plate when said intermediate member is in said first position.

5. The automobile hinge of claim 4, wherein said fastener element contacts a portion of said body attachment plate when said intermediate member is in said first position.

6. The automobile hinge of claim 1, wherein said center flange includes an insert aperture, and wherein said fastener element is adapted to be inserted at least partially through said insert aperture.

7. The automobile hinge of claim 6, wherein said fastener element includes a body portion having at least one securing element, said at least one securing element being adapted to engage said center flange such that movement of said fastener element relative to said intermediate member is limited.

8. The automobile hinge of claim 1, wherein said fastener element includes a fastener receptacle comprising a threaded hole.

9. The automobile hinge of claim 8, wherein said body attachment plate includes an opening and said fastener comprises a threaded fastener, said opening being adapted to enable said threaded fastener to be extended at least partially through said opening to threadably engage said fastener receptacle whereby said intermediate member is secured to said body attachment plate by said threaded fastener and said fastener element.

10. The automobile hinge of claim 1, wherein said body attachment plate includes an opening and an upwardly protruding portion around said opening, said fastener element being adapted to contact said upwardly protruding portion when said intermediate member is placed in said first position, said fastener protruding through said opening in said body attachment plate and received by said fastener element.

11. The automobile hinge of claim 1, wherein said intermediate member includes a panel stop member at said end that is configured to engage a portion of said panel attachment plate to limit pivotal movement of said panel attachment plate.

12. The automobile hinge of claim 1, wherein said intermediate member includes a body plate stop member that is configured to engage a portion of said body attachment plate to limit pivotal movement of said intermediate member away from said first position.

13. The automobile hinge of claim 1, wherein said intermediate member is formed by a stamping process.

14. An automobile hinge for pivotally mounting a pivotable panel component to a vehicle body, said automobile hinge comprising:
a panel attachment plate adapted to be secured to a pivotable panel of a vehicle;
a body attachment plate adapted to be secured to a vehicle body;
an intermediate member pivotally attached to said body attachment plate, said panel attachment plate being pivotally attached to said intermediate member, said intermediate member comprising opposite sidewalls and a center flange extending between said opposite sidewalls, said center flange including an insert aperture and said sidewalls extending generally along said body attachment plate when said intermediate member is pivoted to a first position where a first portion of said intermediate member is positioned generally along said body attachment plate, said intermediate member being securable in said first position relative to said body attachment plate; and
a fastener element adapted to being inserted at least partially through said insert aperture, said fastener element including a body, a flange at an end of said body, and at least one securing element, said flange defining a first end of said fastener element, said body extending from said flange and defining a second end opposite said flange, said body including a fastener receptacle, and said at least one securing element being adapted to engage said center flange such that movement of said fastener element relative to said intermediate member is limited when said fastener element is inserted into said insert aperture; and
a fastener that extends from said body attachment plate and is received at least partially into said fastener receptacle of said fastener element to secure said intermediate member to said body attachment plate in said first position.

15. The automobile hinge of claim 14, wherein said at least one securing element protrudes from said body.

16. The automobile hinge of claim 14, wherein said at least one securing element comprises a plurality of knurls disposed at least partially around said body and proximate said flange.

17. The automobile hinge of claim 14, wherein said sidewalls engage said body attachment plate with said center flange being spaced from said body attachment plate when said intermediate member is in said first position.

18. The automobile hinge of claim 17, wherein said fastener receptacle comprises a threaded passageway at least partially through said body, said fastener comprising a threaded fastener.

19. The automobile hinge of claim 17, wherein said intermediate member has a generally U-shaped cross section and comprises a second portion arranged at an angle to said first portion.

20. The automobile hinge of claim 19, wherein said intermediate member is pivotally attached to said body attachment plate at a junction of said first and second portions and said panel attachment plate is pivotally attached to said intermediate member at an end of said second portion opposite said junction of said first and second portions.

21. A method for making an automobile hinge comprising:
providing a panel attachment plate adapted to be secured to a pivotable panel component of a vehicle;
providing a body attachment plate adapted to be secured to a vehicle body;
providing an intermediate member by stamping a metallic sheet, said stamped intermediate member comprising first and second leg portions extending at an angle to one another, said first and second leg portions comprising a generally U-shaped cross section and having opposite sidewalls and a center flange extending between said opposite sidewalls, said center flange including an insert aperture on said first leg portion;
providing a fastener element adapted to receive a fastener;
inserting said fastener element at least partially through said insert aperture such that a portion of said fastener element is positioned between said opposite sidewalls;
pivotally attaching said intermediate member to said body attachment plate, said intermediate member being pivotally attached to said body attachment plate generally at a junction of said first and second leg portions such that said intermediate member is pivotable toward a first position where said first leg portion is positioned generally along said body attachment plate;
pivotally attaching said panel attachment plate to said intermediate member, said panel attachment plate being pivotally attached to said intermediate member at an end portion of said second leg portion; and
pivoting said intermediate member into said first position and securing said intermediate member to said body attachment plate using a fastener that engages said fastener element such that said intermediate member is generally fixedly secured to said body attachment plate in said first position.

22. The method of claim 21, including attaching a vehicle lift gate to said panel attachment plate and attaching said body attachment plate to a vehicle body.

23. The method of claim 22, wherein said intermediate member is at least initially not in said first position, and wherein said vehicle lift gate is attached to said panel attachment plate and said body attachment plate is attached to the vehicle body before said intermediate member is secured to said body attachment plate with said fastener.

24. The method of claim 23, wherein securing said intermediate member to said body attachment plate comprises extending said fastener through said body attachment plate and engaging said fastener element with said fastener.

25. The method of claim 24, wherein said fastener comprises a threaded fastener and said fastener element includes a fastener receptacle, and wherein engaging said fastener element with said fastener comprises threading said fastener into said fastener receptacle.
